(19) United States
(12) Patent Application Publication
(10) Pub. No.: US 2012/0220220 A1
(43) Pub. Date: Aug. 30, 2012

(54) COMMUNICATIONS SYSTEM PROVIDING DEVICE STATUS INFORMATION BASED UPON NEAR FIELD COMMUNICATION (NFC) AND RELATED METHODS

(75) Inventors: Michael Joseph DeLuca, Boca Raton, FL (US); Robert Cary Gray, Deerfield Beach, FL (US); Arthur Michael Goldberg, Parkland, FL (US)

(73) Assignees: Ontario, Canada), Waterloo (CA); Research In Motion Limited (a corporation organized under the laws of the Province of

(21) Appl. No.: 13/033,819

(22) Filed: Feb. 24, 2011

(51) Int. Cl. H04B 5/00

(52) U.S. Cl. 455/41.1

(57) ABSTRACT

A communications system may include a first electronic device that may include a display having an array of pixels, each pixel retaining a given state between refreshes and without electrical power supplied thereto, a first near-field communications (NFC) device, and a first controller coupled to the first NFC device and the display. The communications system may also include a second electronic device to be removably coupled with the first electronic device and comprising a second NFC device and a second controller coupled thereto. The second controller may be configured to determine status information related to the first electronic device and communicate the status information to the first controller via the first and second NFC devices. The first controller may be configured to display on the display the status information.

### TECHNICAL FIELD

This application relates to the field of communications, and more particularly, to wireless communications systems and related methods.

### BACKGROUND

Mobile communication systems continue to grow in popularity and have become an integral part of both personal and business communications. Various mobile devices now incorporate Personal Digital Assistant (PDA) features such as calendars, address books, task lists, calculators, memo and writing programs, media players, games, etc. These multi-function devices usually allow electronic mail (email) messages to be sent and received wirelessly, as well as access the internet via a cellular network and/or a wireless local area network (WLAN), for example.

Some mobile devices incorporate contactless card technology and/or near field communication (NFC) chips. NFC technology is commonly used for contactless short-range communications based on radio frequency identification (RFID) standards, using magnetic field induction to enable communication between electronic devices, including mobile wireless communications devices. This short-range high frequency wireless communications technology exchanges data between devices over a short distance, such as only a few centimeters.

### BRIEF DESCRIPTION OF THE DRAWINGS

FIG. 1 is a schematic block diagram of a communications system in accordance with an example embodiment.

FIG. 2 is another schematic block diagram of the communications system of FIG. 1 showing the front exterior surfaces of the first and second electronic devices.

FIG. 3 a schematic block diagram of a communications system in accordance with another example embodiment.

FIG. 4 is another schematic block diagram of the communications system of FIG. 3 showing the front exterior surfaces of the first and second electronic devices.

FIG. 5 is a schematic side view diagram of an electronic device in accordance with an example embodiment.

FIG. 6 is a flow diagram illustrating example method aspects associated with the system and devices of FIGS. 1-4.

FIG. 7 is a schematic block diagram illustrating example components of a mobile wireless communications device that may be used in accordance with various implementations.

### DETAILED DESCRIPTION

The present description is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements or steps in alternative embodiments.

Generally speaking, a communications system is disclosed herein which may include a first electronic device that may include a display comprising an array of pixels. Each pixel may retain a given state between refreshes and without electrical power supplied thereto, for example. The first electronic device may also include a first near-field communications (NFC) device and a first controller coupled to the first NFC device and the display.

The communications system may also include a second electronic device to be removably coupled with the first electronic device and comprising a second NFC device and a second controller coupled thereto, for example. The second controller may be configured to determine status information related to the first electronic device and communicate the status information to the first controller via the first and second NFC devices. The first controller may be configured to display on the display the status information, for example.

The first electronic device may include a first electrical connector coupled to the first controller, and the second electronic device may include a second electrical connector coupled to the second controller. The second electrical connector may be configured to be removably coupled to the first electrical connector, for example.

The first electronic device may include a first housing. The first housing may carry the display, the first NFC device, the first controller, and the first electrical connector, for example. The second electronic device may include a second housing. The second housing may carry the second NFC device, the second controller, and the second electrical connector, for example.

The first electronic device may further include a memory coupled to the first controller. The status information may include usage information of the memory, for example.

The first electronic device may further include a power source coupled to the first controller, for example. The power source may be a battery, and the status information may include status information of the battery, for example.

The battery may be a rechargeable battery, for example. The second electronic device may include a rechargeable battery charger. The first NFC device, the display, and the first controller may be configured to be remotely powered.

The first electronic device may further include a substrate supporting the display and the first NFC device. The first electronic device may also include an adhesive layer carrying the substrate. The second electronic device may include a second display coupled to the second controller.

A related electronic device may include a display comprising an array of pixels, with each pixel retaining a given state between refreshes and without electrical power supplied thereto. The electronic device may further include a wireless receiver coupled to the display and configured to receive a wireless signal. The display may be configured to display data thereon based upon the received wireless signal. The wireless receiver and the display may also be configured to be powered by a field received by said wireless receiver.

A related method aspect directed to a method of displaying status information related to the first electronic device. The method may include determining the status information using a second electronic device to be removably coupled with the first electronic device and comprising a second NFC device, and communicating the status information from the second electronic device to the first electronic device via the first and second NFC devices. The method may also include displaying on the display the status information.

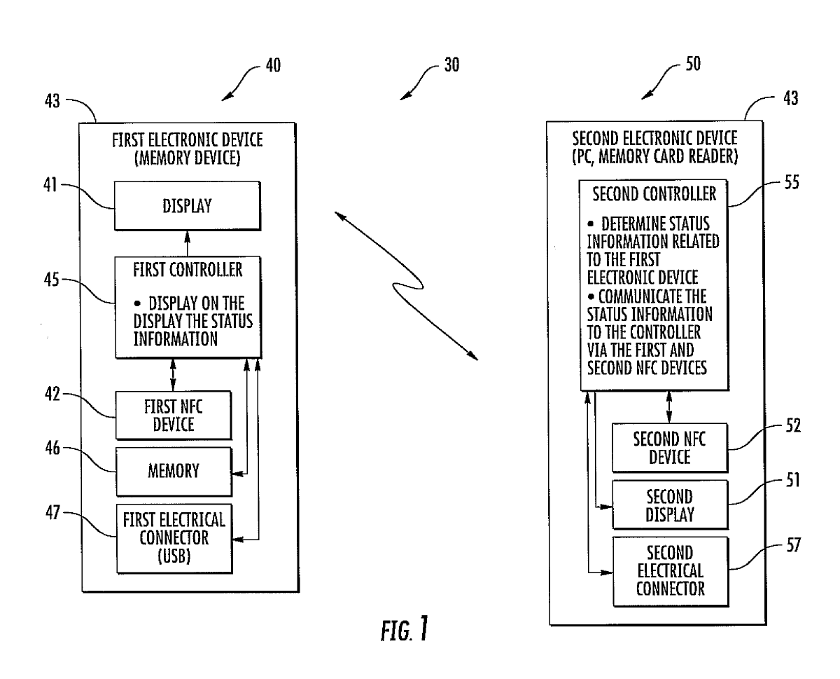

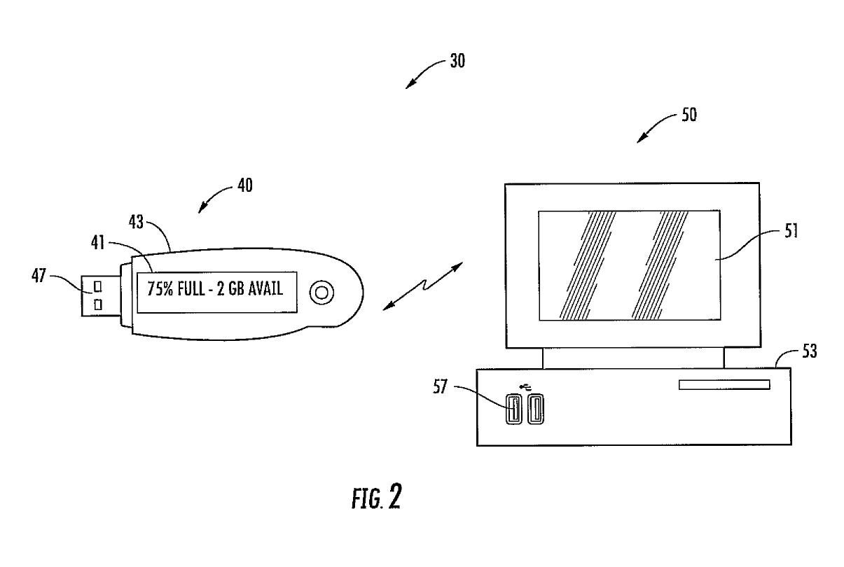

Referring initially to FIGS. 1-2, a communications system 30 illustratively includes a first electronic device 40. In the illustrated example embodiment, the first electronic device 40 is a universal serial bus (USB) memory drive, or thumb drive (See FIG. 2). The first electronic device 40 illustratively includes a first housing 43 and a display 41 carried by the housing. The display 41 includes an array of pixels. Each pixel of the array retains a given state between refreshes and retains the given state without electrical power supplied thereto, thereby maintaining a persistent image with out requiring a constant driving power source. In other words, the display 41 may comprise a bistable display, for example. The display 41 may comprise electronic paper, e-paper, an electronic ink, e-ink, gyricon, electrophoretic, electrowetting or electrofluidic display, for example. Indeed, the display 41 generally mimics the appearance of ordinary ink on paper, and unlike a more conventional flat panel, or active display, which typically uses a backlight to illuminate its pixels, the display reflects light like ordinary paper, for example. The display 41 may be a color display as well as a black and white or monochrome version in some embodiments. Also, color pixels may be used together with black and white pixels to simulate a mixed color display, for example.

The first electronic device 40 also includes a first near-field communications (NFC) device 42 carried by the housing 43. By way of background, NFC is a short-range wireless communications technology in which NFC-enabled devices are “swiped,” “bumped” or otherwise moved in close proximity to communicate. In one non-limiting example implementation, NFC may operate at 13.56 MHz and with an effective range of about 10 cm, but other suitable versions of near-field communication which may have different operating frequencies, effective ranges, etc., for example, may also be used.

The first electronic device 40 also includes a first electrical connector 47 carried by the housing 43. In the illustrated embodiment, the first electrical connector 47 is illustratively a male USB connector for mating with a female USB connector (FIG. 2), for example that may be found on a portable or personal computer. The first electrical connector 47 may be another type of electrical connector, for example, a mini-USB connector.

The first electronic device 40 also includes a memory 46 carried by the housing 43. The memory 46 may be non-volatile memory, for example.

The first electronic device 40 also includes a first controller 45 or processor that is carried the housing 43 and coupled to the memory 46, the first NFC device 42, the display 41, and the first electrical connector 47. The first controller 45 may be implemented using hardware (e.g., memory, etc.) and software components, i.e., computer-readable instructions for causing the first electronic device (i.e. the USB memory device) 40 to perform the various functions or operations described herein.

The communications system 30 also includes a second electronic device 50 that is to be removably coupled to the first electronic device 40. The second electronic device 50 includes a housing 53. The second electronic device 50 is illustratively a personal computer (PC) in the example of FIG. 2 and also includes a second NFC device 52 and a second controller 55 coupled thereto, and both of which are carried by the housing 53. The second electronic device 50 also includes a second display 54 carried by the housing 53. The second display may be an LCD display or other type of display.

The second electronic device 50 or PC also includes a female USE connector 57 or port carried by the housing 53 and for removably coupling with the male USB connector 47 of the USB memory device 40. The second electrical connector 57 may be another type of electrical connector that can be removably coupled to first electrical connector 47.

The second controller 55 is configured to determine status information related to the first electronic device 40 or, more particularly, the memory 46 of the USE memory device. Status information may include capacity and usage information for the memory, for example. The status information may include other information, for example, the name of the drive, file types, or file structure. The status information may be determined based upon device information that may be received when the first and second electronic devices 40, 50 are coupled, for example, via the first and second electrical connectors 47, 57 or USB connector/port. For example, the status information may be determined based upon the file system or structure of data stored in the memory 46. The file system may be used to determine available space and total capacity of the memory 46, for example. The status information may be determined using other data from the memory 47 or other portions of the first electronic device 40. The second controller 55 is configured to communicate the determined status information to the first controller 45 via the first and second NFC devices 42, 52.

The second controller 55 may determine and communicate the status information based upon a read/write instruction to the memory 46. Alternatively or additionally, the second controller 55 may determine and communicate that status information periodically. The status information may be determined and communicated based upon other time periods, or may be determined and communicated in a real-time and/or continuous basis, for example.

The first controller 45 is configured to display, on the display 41, the status information. More particularly, the first controller 45 is configured to display the usage information for the memory 46, for example, an amount of space used or space remaining. In the illustrated embodiment in FIG. 2, the amount of memory space remaining is 25% (75% Full). The status information may be displayed on the display 41 as text or as a graphical indicator, for example.

The status information advantageously remains on display 41 after the first electronic device 40 is removed from or decoupled from the second electronic device PC 50. This may be particularly advantageous in determining which one from among a plurality of first electronic devices, for example, USB memory devices, to use for a particular application. For example, suppose a relatively large amount of data is to be downloaded to a USB memory device, the display advantageously provides a visual indication of remaining space on each of the devices, thus eliminating the need to plug in or couple each to see which memory device can accommodate the large amount of data. Thus, time spent determining a suitable memory device is reduced.

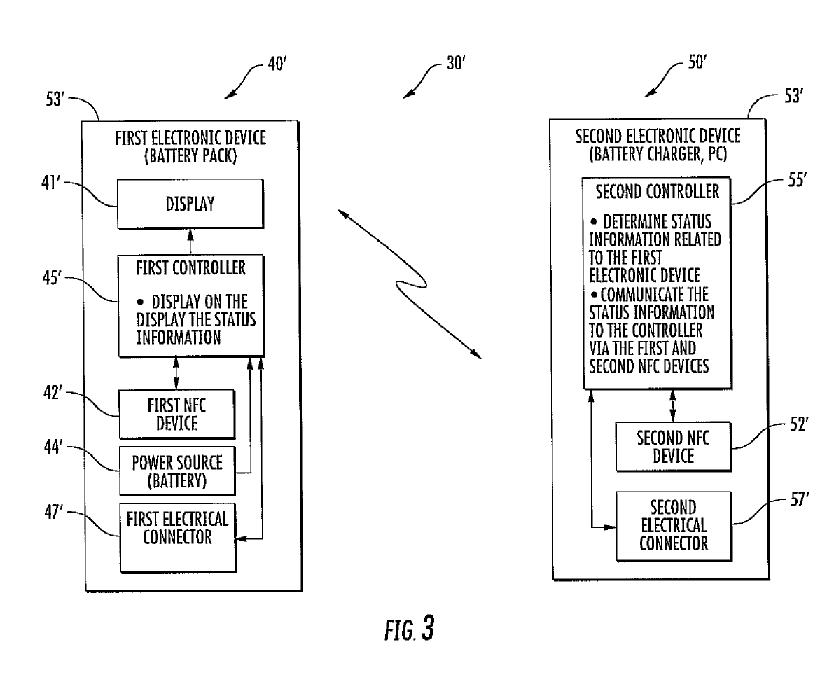

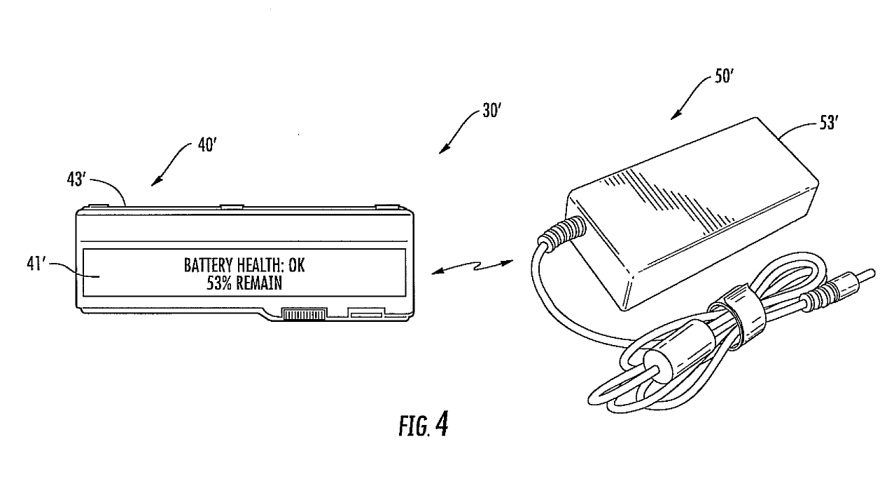

Referring now to FIGS. 3-4, in another example embodiment, the communications system 30′ illustratively includes a first electronic device 40′ that is in the form of a rechargeable battery pack. For example, the rechargeable battery pack may be a mobile device battery pack or laptop computer battery pack. The first electronic device 40′ illustratively includes a housing 43′ and a display 41′ carried by the housing, similar to the display 41 described above.

The first electronic device 40′ also includes a first near-field communications (NFC) device 42′ and a first electrical connector 47′ carried by the housing 43′. The first electrical connector 47′ may be any type of connector, for example, that may be for coupling to a laptop computer, mobile device, etc. The first electronic device 40′ also includes a power source 44′ or battery. The battery 44′ may be a rechargeable battery, for example, a Lithium Ion (LiIon) battery or a Nickel Metal Hydride (NiMH) rechargeable battery. The rechargeable battery 44′ may be another type of battery. In some example embodiments, the battery may provide power to the first controller 45′, the first NFC device 42′, and the display 41′.

The first electronic device 40′ also includes a first controller 45′ or processor that is carried the housing 43′ and coupled to the battery 44′, the first NFC device 42′, the display 41′, and the first electrical connector 47′. The first controller 45′ may be implemented using hardware (e.g., memory, etc.) and software components, i.e., computer-readable instructions for causing the first electronic device 40′ to perform the various functions or operations described herein, for example, managing the power to and from the battery 44′.

The communications system 30′ also includes a second electronic device 50′ that is to be removably coupled to the first electronic device 40′. The second electronic device 50′ is illustratively a rechargeable battery charger, and includes a second NFC device 52′ and a second controller 55′ coupled thereto. The second NFC device 52′ and the second controller 55′ are carried by a housing 53′.

The second electronic device 50′ also includes a corresponding electrical connector 57′ or port, also carried by the housing 53′, for removably coupling with the first electrical connector 47′ of the first electronic device 40′. The second electrical connector 57′ may be another type of electrical connector that may be removably coupled to first electrical connector 47′.

The second controller 55′ is configured to determine status information related to the first electronic device 40′. Status information may include capacity and usage information for the rechargeable battery 44′, and the condition or health of the rechargeable battery, for example. The status information may include other information. The status information may be determined based upon device information that may be received when the first and second electronic devices 40′, 50′ are coupled, for example via the first and second electrical connectors 47′, 57′. For example, the status information may be determined based upon various power values, e.g., a voltage, current, and/or resistance seen by the rechargeable battery charger 50′. This information may be used to determine the status information about the battery 44′. The status information may be determined using other data collected from the rechargeable battery 44′ or other portions of the battery pack 40′. The second controller 55′ is configured to communicate the determined status information to the first controller 45′ via the first and second NFC devices 42′, 52′.

The second controller 55′ may determine and communicate the status information based upon a coupling of the rechargeable battery 44′ to the rechargeable battery charger 50′, for example. Alternatively or additionally, the second controller 55′ may determine and communicate that status information periodically. The status information may be determined and communicated based upon other time periods, or may be determined and communicated in a real-time and/or continuous basis, for example.

The first controller 45′ is configured to display, on the display 41′, the status information. More particularly, the first controller 45′ is configured to display the usage information for the rechargeable battery 44′, for example, an amount of power or usage time remaining. In the illustrated embodiment in FIG. 4, the amount of power remaining is 53% and the battery health is “ok.” The status information may be displayed on the display 41′ as text or as a graphical indicator, for example.

The status information advantageously remains on display 41′ after the rechargeable battery 44′ is removed from or decoupled from the second electronic device 50′. This may be particularly advantageous in determining which one from among a plurality of batteries to use. For example, suppose at least four hours a laptop computer is desired, the display 41′ advantageously provides a visual indication of how much power remains in each rechargeable battery so that the one with the most, for example, power remaining can be selected. This eliminates the need to plug in or couple each to see which rechargeable batteries can accommodate the desired duration of usage. Thus, time spent determining a suitable rechargeable battery is reduced.

Additionally, in some example embodiments, there may be more than one second electronic device 50′. By way of example, the first electrical device 40′ may be in the form of a rechargeable battery pack for a mobile phone, for example. The second electronic devices 50′ may be in the form of a rechargeable battery charger and the mobile phone. In other words, the mobile phone may determine and communicate the status of the rechargeable battery when it is coupled to it. When the rechargeable battery is removed and placed on the charger, the status may be determined and updated again. Of course, any number of second electronic devices 50′ may be used to coupled with a given first electronic device 40′.

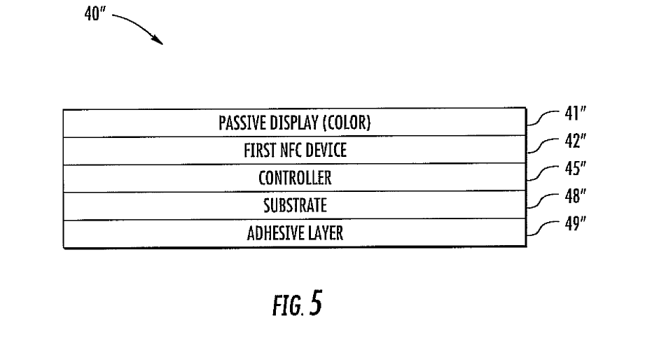

Referring now to FIG. 5, in another exemplary embodiment, an electronic device 40″ includes a substrate 48″ and the display 41″ is carried by the substrate. The substrate 48″ may be a flexible, plastic sheet, for example. In some embodiments, the substrate 48″ may be a rigid sheet or layer and formed from other materials.

The display 41″ is similar to the bistable display described above with respect to FIGS. 1-4 in that each pixel of the array retains a given state between refreshes and retains the given state without electrical power supplied thereto. The display 41″, by virtue of the substrate 48″ being flexible, for example, may also be flexible.

The first NFC device 42″ and the controller 45″ are also carried by the substrate 48″ and cooperates with the display 41″ to display the status information thereon based upon NFC communications with the second NFC device 52″. An optional adhesive layer 49″ is also carried by an outer surface of the substrate 48″. The adhesive layer 49″ may be a pressure sensitive adhesive, for example. The adhesive layer 49″ may include other types of adhesives. A release layer (not shown) may be positioned over the adhesive layer 49″ prior to application of the electronic device 40″ to a desired surface.

The first NFC device 42″, controller 45″ and the display 41″ are advantageously powered by a field received by the first NFC device 43″. That is the first NFC device 43″ may be configured as a passive NFC device. For example, the field may be an electromagnetic field, which in some example embodiments may be inclusive of the NFC communications. Being powered by an electromagnetic field, for example, reduces reliance on a separate power source, for example, a battery, or other power source that may be received from a second electronic device when it is coupled to the first electronic device 40″. It should also be noted that alternate structures for the device of FIG. 5 are anticipated. For example the substrate 48″ may be adjacent to our contained within the bistable display 41″ with the controller 45″ and first NFC device 42″ affixed to the back of the display 41″ or substrate 48″, with adhesive layer 49″ optionally incorporated into electronic device 40″ depending upon the application.

Indeed, the first electronic device 40″ may be a stand-alone device, which is advantageously configured as a sticker, adhesive note, notepad or other information display device. In one example, electronic device 40″ is configured much like an “electronic” adhesive note. A graphic or text message is composed on the second electronic device, which may be a NFC enabled smart phone. The smart phone is then brought into close proximity with the electronic adhesive note where the NFC link not only communicates the data for rendering the image on display 41″ but also momentary powers the display 41″, the first NFC device 42″ and the controller 45″. Controller 45″ then processes the data in order to render the image using power wirelessly communicated from the smart phone over the NFC link. Since the display is bistble, the displayed image can be maintained substantially indefinitely on the electronic adhesive note. Since the smart phone provides all necessary power to modify the display, the electronic adhesive note requires no battery or independent power source and thus may be both cost and sized reduced relative to battery powered display devices. Thus the electronic adhesive note may be thin and inexpensive and placed in any location where the recipient of the intended message may be present. Furthermore, unlike conventional paper adhesive notes which are typically disposed of after use, the display of the electronic adhesive note may be rewritten by subsequent interfaces with smart phones or other types NFC devices. Finally, the data representation of the displayed image may be maintained in non-volatile memory included in the controller 45″. Should the message recipient also have an NFC enabled smart phone, then the recipient's smart phone could not only be optionally used to composed a reply message for display on the electronic adhesive note, but the data representative of the image may be transferred from the controller to the recipient's smart phone when it forms an NFC link, thereby allowing the recipient's smart phone to maintain a copy of the information displayed on the electronic adhesive note for later use.

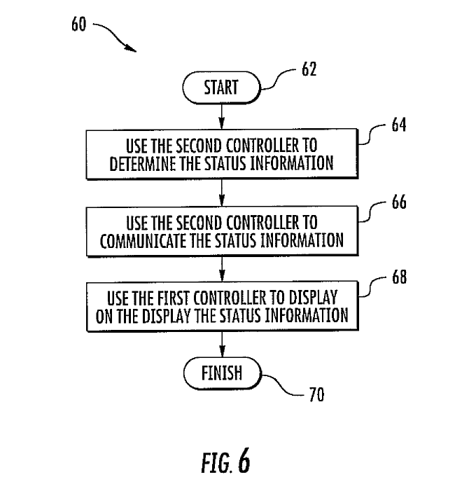

Referring now to the flowchart 60 of FIG. 6, related method aspects are now described. Beginning at Block 62 the method includes using the second controller 55 to determine the status information (Block 64). At Block 66, the method includes using the second controller 55 to communicate the status information to the first controller 45 via the first and second NFC devices 42, 52. The method further includes using the first controller 45 to display 41 on the display the status information at Block 68. The method ends at Block 70.

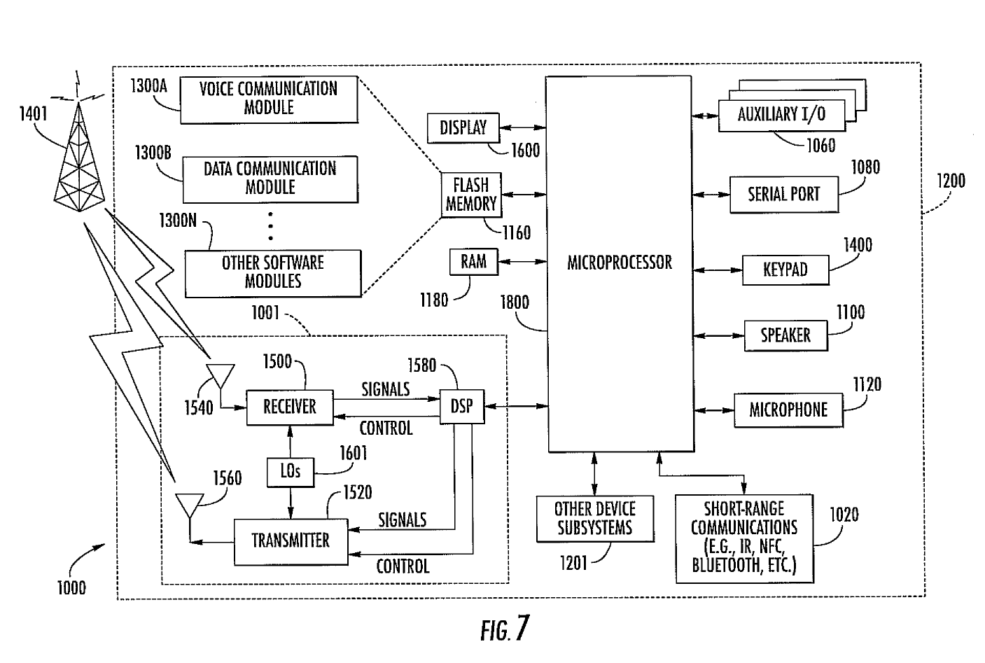

Example components of a mobile wireless communications device 1000 that may be used in accordance with the above-described embodiments are further described below with reference to FIG. 7. The device 1000 illustratively includes a housing 1200, a keyboard or keypad 1400 and an output device 1600. The output device shown is a display 1600, which may comprise a full graphic LCD. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 7. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having data and, optionally, voice communications capabilities. In addition, the mobile device 1000 may have the capability to communicate with other computer systems via the Internet.

Operating system software executed by the processing device 1800 is stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3GPP, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore typically involves use of a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device may also be used to compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, a Bluetooth™ communications module to provide for communication with similarly-enabled systems and devices, or a near field communications (NFC) sensor for communicating with a NFC device or NFC tag via NFC communications.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A communications system comprising:
a first electronic device comprising
a display comprising an array of pixels, each pixel retaining a given state between refreshes and without electrical power supplied thereto,
a first near-field communications (NFC) device, and
a first controller coupled to said first NFC device and said display; and
a second electronic device to be removably coupled with said first electronic device and comprising a second NFC device and a second controller coupled thereto and configured to determine status information related to said first electronic device and communicate the status information to said first controller via said first and second NFC devices;
said first controller configured to display on said display the status information.

2. The communications system of claim 1, wherein said first electronic device comprises a first electrical connector coupled to said first controller; and wherein said second electronic device comprises a second electrical connector coupled to said second controller and configured to be removably coupled to said first electrical connector.

3. The communications system of claim 2, wherein said first electronic device comprises a first housing; wherein said first housing carries said display, said first NFC device, said first controller, and said first electrical connector; wherein said second electronic device comprises a second housing; and wherein said second housing carries said second NFC device, said second controller, and said second electrical connector.

4. The communications system of claim 1, wherein said first electronic device further comprises a memory coupled to said first controller; and wherein the status information comprises usage information for said memory.

5. The communications system of claim 1, wherein said first electronic device further comprises a power source coupled to said first controller.

6. The communications system of claim 5, wherein said power source comprises a battery; and wherein the status information comprises status information of said battery.

7. The communications system of claim 6, wherein said battery comprises a rechargeable battery; and wherein said second electronic device comprises a rechargeable battery charger.

8. The communications system of claim 1, wherein said first NFC device, said display, and said first controller are configured to be remotely powered.

9. The communications system of claim 1, wherein said first electronic device further comprises a substrate supporting said display, said first NFC device, and said first controller; and an adhesive layer carrying said substrate.

10. The communications system of claim 1, wherein said second electronic device comprises a second display coupled to said second controller.

11. An electronic device comprising:
a display comprising an array of pixels, each pixel retaining a given state between refreshes and without electrical power supplied thereto;
a memory;
a first near-field communications (NFC) device configured to receive status information related to said memory communicated from a second NFC device; and
a controller coupled to said first NFC device, said display, and said memory and configured to display on said display the status information.

12. The electronic device of claim 11, wherein the status information comprises usage information of said memory.

13. The electronic device of claim 11, wherein said first NFC device, said display, and said controller are configured to be remotely powered.

14. An electronic device comprising:
a display comprising an array of pixels, each pixel retaining a given state between refreshes and without electrical power supplied thereto;
a power source;
a first near-field communications (NFC) device configured to receive status information related to said power source communicated from a second NFC device; and
a controller coupled to said first NFC device, said display, and said power source and configured to display on said display the status information.

15. The electronic device of claim 14, wherein said power source comprises a battery; and wherein the status information comprises status information of said battery.

16. The electronic device of claim 14, wherein said first NFC device, said display, and said controller are configured to be remotely powered.

17. An electronic device comprising:
a display comprising an array of pixels, each pixel retaining a given state between refreshes and without electrical power supplied thereto; and
a wireless receiver coupled to said display and configured to receive a wireless signal;
said display being configured to display data thereon based upon the received wireless signal;
said wireless receiver and said display being configured to be powered by a field received by said wireless receiver.

18. The electronic device of claim 17, further comprising a substrate supporting said display and said wireless receiver and an adhesive layer carrying said substrate.

19. The electronic device of claim 17, wherein said wireless receiver comprises a near-field communications (NFC) receiver.

20. The electronic device of claim 17, wherein the electronic device is a standalone device exclusively powered by the wireless signal and the electronic device includes no other power source.

21. The electronic device of claim 20 further comprising a wireless transmitter powered by the field received by said wireless receiver; and wherein the electronic device further comprises a non-volatile memory for storing image data representative of the display data; and wherein said wireless transmitter is configured to transmit the image data.

22. A method of displaying status information related to a first electronic device comprising a display comprising an array of pixels, wherein each pixel retains a given state between refreshes and without electrical power supplied thereto, and a first near-field communications (NFC) device for the first electronic device, the method comprising:
determining the status information using a second electronic device to be removably coupled with the first electronic device and comprising a second NFC device;
communicating the status information from the second electronic device to the first electronic device via the first and second NFC devices; and
displaying on the display the status information.

23. The method of claim 22, wherein the first electronic device further comprises a memory; and wherein the status information comprises usage information of the memory.

24. The method of claim 22, wherein the first electronic device further comprises a power source.

25. The method of claim 24, wherein the power source comprises a battery; and wherein the status information comprises status information of said battery.

26. The method of claim 25, wherein the battery comprises a rechargeable battery; and wherein the second electronic device comprises a rechargeable battery charger.

27. The method of claim 22, further comprising remotely powering the first NFC device, the display, and the first controller.
